(19) United States
(12) Patent Application Publication
(10) Pub. No.: US 2025/0368793 A1
(43) Pub. Date: Dec. 4, 2025

(54) THERMAL PROTECTION SYSTEMS HAVING CERAMIC COATINGS OPTIONALLY WITH METAL CARBIDE COATINGS

(71) Applicant: Battelle Memorial Institute, Columbus, OH (US)

(72) Inventors: Albert J. Darling, Bexley, OH (US); Christopher F. Buurma, Gahanna, OH (US); Richard G. Rateick, Jr., South Bend, IN (US); Thomas Deucher, Strongsville, OH (US); Brent J. Carey, Columbus, OH (US); Thomas Morton Hamner, Plain City, OH (US)

(21) Appl. No.: 18/876,325

(22) PCT Filed: Jun. 23, 2023
(86) PCT No.: PCT/US23/68953

§ 371 Date: Dec. 18, 2024

Related U.S. Application Data
(60) Provisional application No. 63/355,378, filed on Jun. 24, 2022.
(60) Provisional application No. 63/391,920, filed on Jul. 25, 2022.

(51) Int. Cl. C08J 7/12; C08J 7/06

(52) U.S. Cl. CPC C08J 7/123; C08J 7/06

(57) ABSTRACT

The present disclosure relates to the formation of thermal protection systems based on the formation of ceramic coatings. Such ceramic coatings may be derived from polymeric resins and may be applied over carbon-carbon (C/C) composites. The ceramic coatings may optionally contain a metal carbide coating.

### CROSS-REFERENCE TO PRIOR APPLICATIONS

This application claims priority to and the benefit of U.S. Provisional Application No. 63/335,378 filed Jun. 24, 2022, the entirety of which is hereby incorporated by reference and to U.S. Provisional Application No. 63/391,920 filed Jul. 25, 2022, the entirety of which is hereby incorporate by reference.

### FIELD

The present disclosure relates to the formation of thermal protection systems based on the formation of ceramic coatings. Such ceramic coatings may be derived from polymeric resins and may be applied over carbon-carbon (C/C) composites. The ceramic coatings optionally can include a metal carbide coating.

### BACKGROUND

The development of advanced materials for hypersonic platforms is important to national defense and commercial aerospace applications. At high speeds, the temperature of materials used to form aircraft and projectiles (e.g., nose cones, leading edges, control surfaces and the like) can exceed 2200° C. due to aerodynamic heating at flight speeds of up to MACH 20. Thermal protection systems (TPS) systems employing carbon-carbon (C/C) composites have been developed to protect sensitive components of aircraft and projectiles to improve their durability at such speeds.

C/C composites are typically manufactured by filling spaces in a multi-dimensional weave of carbon fiber with a relatively carbon-rich matrix via liquid or vapor phase infiltration, after which the resulting structure is slowly heat treated in a furnace at 1,000-1,500° C. to drive off everything except carbon. The resulting carbonized structure may then be subjected to a 1,500-2,750° C. heat treatment to refine the crystal structure (e.g., to form graphitic (sp² hybridized) carbon), resulting in improved high temperature stability and strength. This process can take months to produce a single part, as rapid heat treatment can lead to the development of defects (e.g., pores, cracks, etc.) that can lead to critical failure of the part and/or poor mechanical characteristics. Consequently, traditional processes for forming C/C composites are extremely expensive due to the repeated high-temperature heating cycles and the need for specialized capital equipment needed for processing large parts. Moreover, traditional processes for forming C/C composites have significant failure rate due to the formation of mechanically compromised porous and brittle structures that can result from bulk high-temperature heat treatment. As a result, conventional processes for forming C/C composites may be pragmatically or economically difficult to implement in large scale projects, or with projects that require part delivery within a short time frame.

### SUMMARY

A composite part comprising a substrate, a subsurface layer comprising graphite with a cellular structure, a graphitic layer wherein the graphitic layer comprises graphite in an amount greater than the graphite present in the subsurface layer and a ceramic coating on the graphitic layer.

A method of forming a composite part comprising providing a substrate having polymer resin and one or a plurality of additives and performing, with a laser, a first heating operation on the polymer resin and one or a plurality of additives and forming a subsurface layer on the substrate, the subsurface layer comprising graphite with a cellular structure. Then one performs with a laser a second heating operation on the subsurface layer and forms a graphitic surface layer on the subsurface layer, wherein the graphitic layer comprises graphite in an amount greater than the graphite present in said subsurface layer, and applying a preceramic polymer to the graphitic surface layer and laser heating to form a ceramic coating.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates the use of the SHP-199 (HfC precursor polymer) in combination with SMP-10 (SiC precursor polyimer) after drying and curing.

FIG. 2 illustrates the use of the SHP-199 (HfC precursor polymer) as a preceramic polymer coating layer on a carbon-carbon (C/C) composite utilized for thermal protection.

FIG. 3 illustrates a ceramic polymer precursor, containing filler, applied to a carbon-carbon (C/C) composite that is then tilted at an angle of 65°.

FIG. 4 illustrates the resulting relatively even coating of ceramic polymer precursor containing filler.

### DETAILED DESCRIPTION OF PREFERRED EMBODIMENTS

The present disclosure relates to the formation of ceramic coatings that are preferably derived from polymeric resins, which polymeric resins may be selectively laser heated to provide such coatings. The polymer resins may therefore be identified herein as a preceramic polymer. A preceramic polymer is reference to a polymeric material which, upon heating, provides a ceramic compound. Selective laser heating (SLH) of preceramic polymer-coated matrix composites (PMCs) now provides a useful platform to form anti-ablative ceramic coatings on, e.g., thermal protection system (TPS) materials. Reference to a ceramic coating herein is reference to compound containing carbon and an inorganic element, preferred examples of which include SiC or HfC.

Preferred preceramic polymers are processable liquids which can now be applied to a selected TPS surface via brush. They may then be initially heated to evaporate water, preferably at temperatures of 80° C. to 100° C. and are then preferably first cured at relatively low temperatures (150° C.-200° C.) to allow for ease of handling. Such preceramic polymers may be preferably obtained from Starfire Systems as the StarPCS™ SMP-10 silicon carbide matrix precursor or SHP-199™ HfC precursor which forms a thermally stable hafnium carbide (HfC).

Selective laser heating (SLH) treatment of the above referenced cured coatings under inert atmosphere (which can be achieved via a relatively small, optically accessible environmental chamber with flowing inert gas) is contemplated to allow for the formation of amorphous or crystalline ceramic coatings, depending on the laser conditions applied. It is also contemplated that such method will provide anti-ablative ceramic coatings with relatively low or no modification of the mechanical properties of the underlying coating structure, allowing for the fabrication of TPS materials with desirable mechanical and anti-ablative properties.

The ceramic coatings herein are more specifically contemplated to have particular use on carbon-carbon (C/C) composite utilized for thermal protection. Such carbon-carbon composites may preferably include those that comprise a substrate, a subsurface layer comprising graphite with a cellular structure, a graphitic layer (sp² hybridized carbon) wherein the graphitic layer comprises graphite in an amount greater than the graphite present in said subsurface layer. The subsurface layer preferably includes pores with a diameter of greater than 0 to about 150 microns. The subsurface layer preferably has a surface and a thickness perpendicular to the surface in the range of greater than or equal to about 500 microns to about 5.0 mm. The graphitic layer preferably has a surface and a thickness perpendicular to said graphitic surface in the range of about 300 microns to about 1.5 mm. The subsurface layer preferably has a through-plane, perpendicular to the surface having a thermal conductivity of less than or equal to about 5 Watts per meter per Kelvin. The graphitic layer preferably has a surface and a thermal conductivity that is parallel to said graphitic layer surface in the range of about 10 Watts per meter per Kelvin to about 600 Watts per meter per Kelvin. The graphitic layer has a surface and a thickness, and preferably a thermal conductivity in thickness (TC_{THICKNESS}) perpendicular to said graphitic layer surface, and a thermal conductivity parallel to said graphitic layer surface (TC_{SURFACE}), wherein TC_{SURFACE}=(2-100)×(TCTHICKNESS).

Preferably, the substrate comprises a polymer matrix composite (PMC) material including polymer matrix resin and one or more additives such as carbon fibers, single and/or multi-walled carbon nanotubes (CNT), graphene, graphene oxide (GO), reduced graphene oxide (RGO), carbon black (CB), and/or boron nitride nanotubes (BNNT). Such additives are preferably present at a level of 80.0 wt. % to 20.0 wt. %. The polymer resin of the substrate is preferably selected from the group consisting of phenolic resins, polyaryletherketones (PAEK), polyether ketones (PEK), polyetheretherketone (PEEK) or polyetherketoneketone (PEKK), polyether ketone ether ketone (PEKEKK), polyetherimide (PEI), polyimides, polyphenylene, polyarylacetylene, phthalonitrile, benzoxazine, PAEK co-polymer with PEI and/or polyethersulfone (PES), polyphenylenesulfide (PPS), and blends thereof. The polymer resin is therefore preferably present at a level of 20.0 wt. % to 80.0 wt. %.

In particular, as carbon-carbon (C/C) composites may be employed in general for certain relatively high temperature applications, they may be prone to oxidation at temperatures above 500° C. at atmospheric conditions. It is contemplated herein that the anti-ablative ceramic coatings herein can now serve as a barrier to protect such carbon-carbon (C/C) composites from issues arising from oxidative degradation.

By way of representative example, an initial coating of 66.7 mg/in² of preceramic polymer SMP-10 on a graphitic surface when cured and selective laser heat treated provided a baseline layer comprised of SiC crystals and graphitic material ranging from 20-75 μm, with variance and dependence due to the material's surface topography. When three consecutive layers of preceramic polymer SMP-10 are laid, cured, and treated with the conditions disclosed herein, a layer is formed with an average thickness around 80-100 μm and average SiC crystals of about 40-70 μm. Multiple layer applications of SMP-10 provided infiltration of the SMP-10 into cracks and porosity leading to the formation of SiC and graphitic material in these void spaces and cracks, infiltrating up to 250 μm past the surface layering of the coating. It is therefore contemplated that the ceramic coatings herein to be applied to the carbon-carbon composites may be in the range of 10 μm to 500 μm, including all individual values and increments therein.

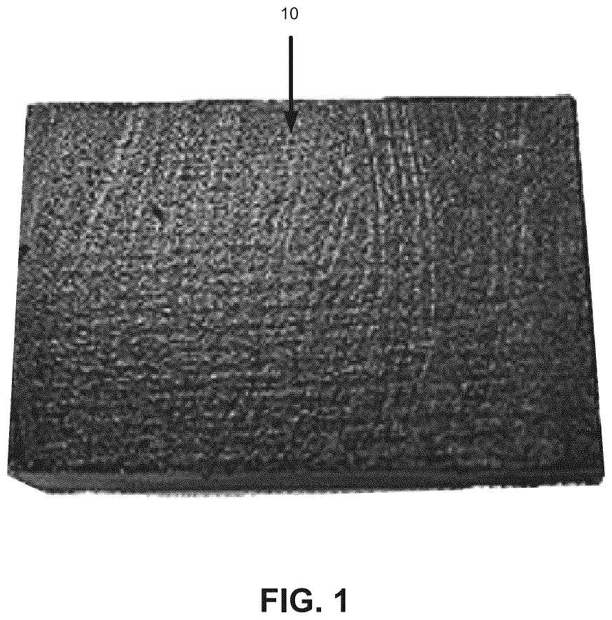

Additionally, it has also been observed that the ceramic coatings herein may more preferably comprise mixing of different ceramic polymer precursors for application to a carbon-carbon (C/C) composite, where one of the ceramic polymeric precursors, after selective layer heating, provides a SiC layer, and another of the ceramic polymeric precursors, after selective layer heating, provides a HfC layer. A preferred technique therefore entails mixing SHP-199 (providing a HfC layer after selective laser heating) with SMP-10 (providing a SiC layer after selective laser heating). Preferably, the volume % ratio of the SHP-199 to the SMP-10 is 2:1 to 4:1. As discussed further below, one may also incorporate a surfactant. The combination of SHP-199 and SMP-10 results in an emulsion where the SHP-199 is suspended within the SMP-10, creating a layering of preceramic where particles of the SHP-199 (HfC precursor polymer) are embedded within the SMP-10 (SiC precursor polymer). FIG. 1 illustrates the use of the SHP-199 in combination with SMP-10 after drying and curing. As illustrated at 10, there is a relatively even spread of this combination of ceramic precursor polymers.

It is also contemplated that as described above and illustrated in FIG. 1, the use of the combination of the two different ceramic polymer precursors provides improved resistance to the formation of cracking/defects, and also prevents oxygen infiltration and offers improved ablation resistance. Moreover, the combination of the two different ceramic polymer precursors is contemplated to provide a SiC-HfC layer that itself can act as bonding layer between a SiC and HfC layer. Accordingly, it can be appreciated that one can form a plurality of ceramic layers where the coefficient of thermal expansion (CTE) between the layers can now be controlled so that there are relatively smaller differences in the CTE between such layers. For example, a first layer of SiC, and a second layer of HfC, can have a relatively large difference in CTE, in response to elevated temperature, which may then lead to relatively large difference in expansion rates, and stresses and cracking. Alternatively, by now placing a SiC-HfC layer between a layer of SiC and HfC, there are relatively smaller differences in CTE between the layers, and an improved resistance to cracking upon application of heat.

Expanding upon the above, one may more preferably incorporate a surfactant into the ceramic forming polymer to facilitate dispersion of the applied layer. The surfactant may preferably be present at a level of 0.1% (wt.) to 5.0% (wt.) in the ceramic forming polymer, including all values and increments therein. For example, the surfactant may preferably be present in the ceramic forming polymer at a level of 0.5 wt. % to 4.0 wt. %, or at a level of 0.5 wt. % to 2.5 wt. %, or even 0.5 wt. % to 2.0 wt. %.

For example, when employing SHP-199™ HFC, one may preferably include Tergitol™ 15-S-7 surfactant, available from Dow, in the ceramic forming polymer, which is a nonionic surfactant, which is a general reference to a compound that does not undergo ionization when dissolved in water. Another exemplary nonionic surfactant is TWEEN™ 80 available from Sigma-Aldrich, and identified as polyoxyethylenesorbitan monooleate. Non-ionic surfactants suitable herein therefore preferably rely upon covalently bonded oxygen-containing hydrophilic groups which are bonded to hydrophobic parent structures. Examples of hydrophilic groups include oxyethylene groups, hydroxyl groups, and amide groups. Hydrophobic groups typically include hydrocarbons, fatty alcohols, synthetic alcohols, or glyceryl esters/oils. Tergitol™M 15-S-7 surfactant, as a particularly preferred surfactant herein, is identified as a non-ionic secondary alcohol ethoxylate surfactant, which has a cloud point of 37° C. and a HLB value of 12.1.

Expanding on the above use of surfactant, the incorporation of surfactant in the selected ceramic precursor polymer, for use on carbon-carbon (C/C) composites utilized for thermal protection, is observed to facilitate dispersion of the applied precursor layer, thereby providing a relatively smoother and consistent layering of the ceramic polymer precursor to be converted, via the preferred use of selective laser heating, to a ceramic coating layer containing either SiC, a mixture of Si—C with HfC, or a HfC layer.

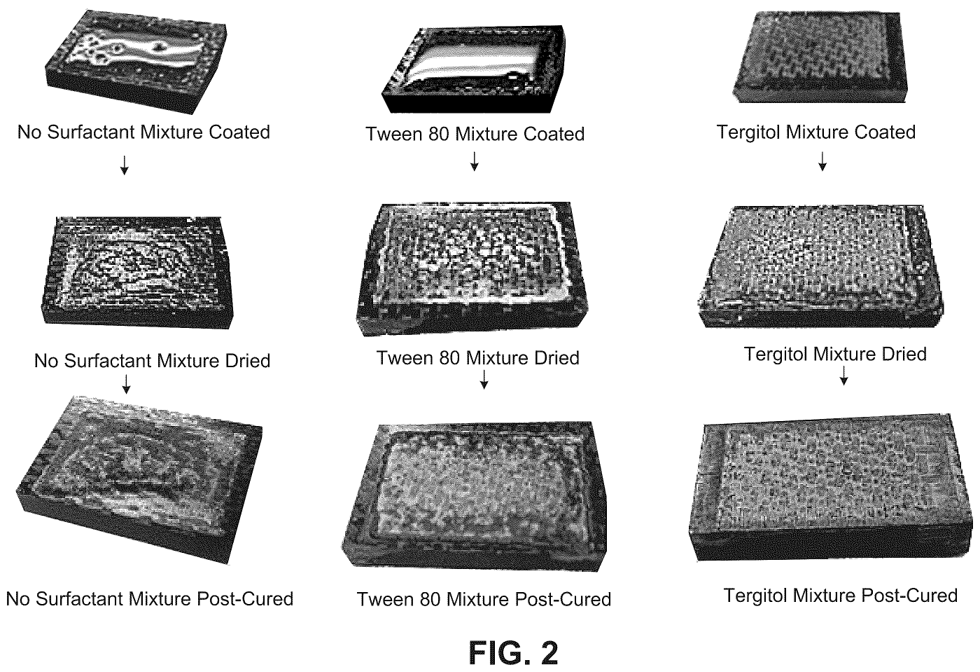

FIG. 2 next illustrates the use of SHP-199, as a preceramic polymer coating layer, on a carbon-carbon (C/C) composite herein utilized for thermal protection, illustrating the results of curing the SHP-199, via oven heating, in the absence or present of two representative surfactants, Tween™ 80 or Tergitol™ 15-S-7, at the preferred levels noted herein. As can be readily observed, the use of the aforementioned surfactants provides a relatively more distributed layering of the preceramic polymer after coating, drying and curing.

Accordingly, the present invention therefore relates to a composite part comprising: a substrate, a subsurface layer comprising graphite with a cellular structure; a graphitic layer; wherein the graphitic layer comprises graphite in an amount greater than the graphite present in said subsurface layer, and a ceramic coating on said graphitic layer. The ceramic coating comprises SiC or HfC. The ceramic coating may be preferably formed on said graphitic layer by applying a ceramic forming polymer to said graphitic layer, followed by curing with heat, and then laser heating, and forming the ceramic coating. The ceramic forming polymer may preferably contain a surfactant, more preferably a non-ionic surfactant.

In addition, the ceramic forming polymer used for forming the ceramic coating may itself preferably be a single ceramic forming polymer, or a mixture of two different ceramic forming polymers, where one ceramic forming polymer provides a SiC ceramic, and other provides a HfC ceramic. Accordingly, it is contemplated that one may now provide a graphite layer coated with a layer of SiC, a layer of SiC-HfC, and a layer of HfC, by selective laser heating.

With regards to the use of the aforementioned ceramic polymer precursors, it has also now been found that preferably, one can introduce a filler material, preferably of an inorganic compound, to adjust the viscosity of the ceramic polymer precursor when applied to the aforementioned carbon-carbon (C/C) composite. Preferably, such fillers include one or more of SiC, HfC, TaC, HfB₂, ZrB₂, and/or BN. In addition, such fillers preferably have a particle size in the range of 1 nm to 500 nm, more preferably, 1 nm to 100 nm. The level of such fillers in the ceramic polymer precursor is preferably selected to increase the viscosity of the ceramic polymer precursor. Preferably, the level of such filler in the ceramic polymer precursor is in the range of up to 1 part filler to 10 parts ceramic polymer precursor to 4 parts filler to 10 parts ceramic polymer precursor, including all individual values and increments therein. Accordingly, a loading level of 10% (wt.) to 40% (wt.). More preferably, the filler is incorporated in the ceramic polymer precursor at a level of 2 parts filler to 10 parts ceramic polymer precursor to 3 parts filler to 10parts ceramic polymer precursor. That is, a preferred loading level of 20% (wt.) filler to 30% (wt.) filler in the ceramic polymer precursor.

In particular, the viscosity of the ceramic polymer precursor is now preferably increased so that the ceramic polymer precursor can be applied to the carbon-carbon (C/C) composite, and be tilted up to an angle of 65.0°, such that the ceramic polymer precursor layer consistency is maintained That is, the ceramic polymer precursors, with filler, when tilted at an angle in the range of 1.0° to 65.0°, including all individual values and increments therein, will not flow downward and thereby cause a variation of more than +/−10.0% in the thickness of the ceramic layer that is formed. More preferably, the variation in thickness of the ceramic layer that is formed, when the carbon-carbon (C/C) composite with the ceramic polymer precursors, and the fillers herein, when tilted at an angle in the range of 1.0° to 65.0°, is contemplated to not have a variation in the thickness of the ceramic layer that is formed of more than +/−10.0%, or +/−9.0%, or +/−8.0%, or +/−7.0%, or +/−6.0%, or +/−5.0%, or +/−4.0%, or +/−3.0%, or +/−2.0%, or +/−1.0%.

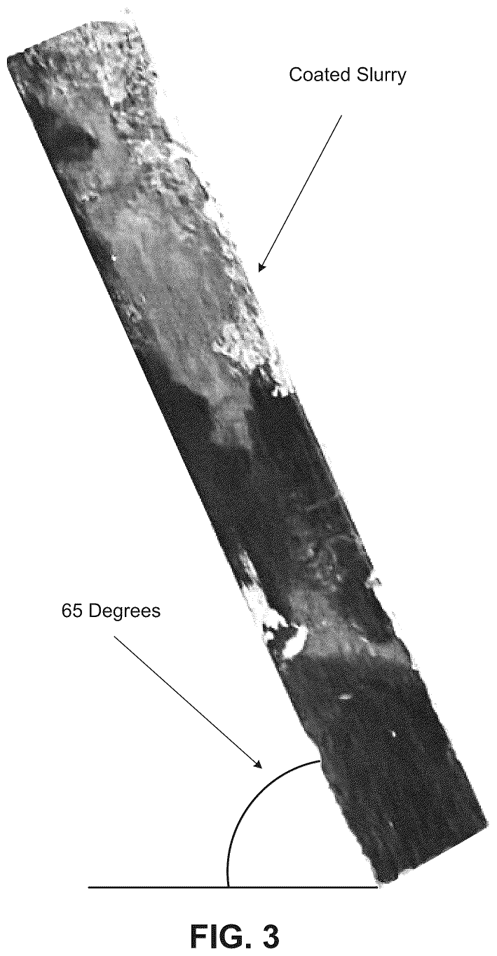

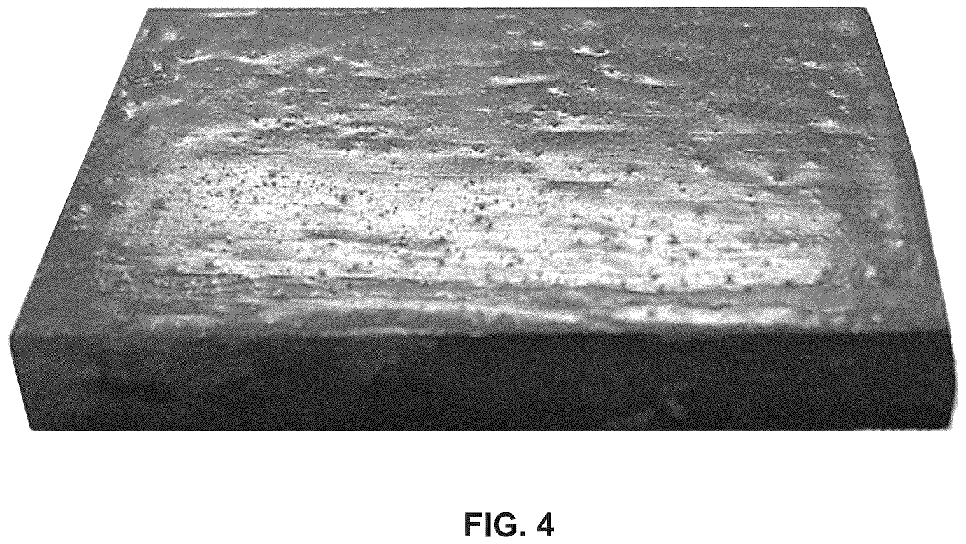

FIG. 3 shows a ceramic polymer precursor, containing filler herein, applied to a carbon-carbon (C/C) composite, that is then tilted at an angle of 65.0°, where a relatively even coating of the ceramic polymer precursor can be observed, which can be seen better in FIG. 4. It may therefore be appreciated that by use of the fillers herein, dispersed in the ceramic polymer precursor, relatively complex shaped parts, with both horizontally disposed and vertically disposed wall sections, can be coated, where the coating will not otherwise flow downward, due to gravity, and provide relatively uneven ceramic coatings, when the ceramic polymer precursor layers are cured and subject to selective laser heating.

In addition, it is contemplated that the fillers noted above are included in the ceramic polymer precursors, such as SMP-10 and/or SHP-199, are incorporated either alone, or in the presence of surfactants, preferably the herein identified non-ionic surfactants. The surfactants are contemplated to therefore increase the dispersibility of the fillers in the ceramic polymer precursors.

The use of the aforementioned fillers in the ceramic polymer precursors are also contemplated to have additional benefits, other than increasing viscosity. For example, the incorporation of the fillers is contemplated to allow one to adjust the coefficient of thermal expansion (CTE) of the ceramic layer that is formed, as well as the control of nucleation sites that are formed during the SLH-induced conversion of the ceramic polymer precursors to an ceramic layer. It should therefore be appreciated that such control of nucleation is reference to the ability to control the grain size in the formed ceramic layer, where, e.g., larger grain size would increase in-plane thermal conductivity of the ceramic coated carbon-carbon (C/C) composite.

By way of a representative example, concerning the use of filler in a ceramic polymer precursor, preparation proceeds by incorporation of SiC filler, having a particle size of less than or equal to 100 nm into a ceramic polymer precursor (SMP-10) to form a slurry using magnetic stirring at 750 rpm until the filler appears thoroughly mixed, which takes about 15.0 minutes. A vacuum may preferably be applied from a water aspirator to degas the slurry. A surfactant may be included, such as the herein referenced nonionic surfactant Tergitol 15-S-7. The slurry is then applied to a carbon-carbon (C/C) composite, which as noted, may now be tilted up to an angle of 65.0°, where the ceramic polymer precursor has the requisite viscosity to avoid flow and the formation of a relatively uneven coating.

In addition to the above, the ceramic coating on the graphite layer may itself now preferably include a metal carbide coating. More preferably, a metal carbide coating derived from a mixture of metal nanoparticles and a polymeric resin upon treatment with laser that provides a carbon to react with the metallic nanoparticles and form the carbide. The polymer preferably contains relatively low levels of oxygen (≤ 1.0% (wt.)) or no oxygen. The carbon-producing polymers may preferably be selected from polyphenylene, polyarylacetylene, or polyphenylenesulfide (PPS).

The aforementioned metal nanoparticles are preferably from Group IV-VI of the periodic table (e.g., preferably Ti, Zr, Hf, V, Nb, Ta, Cr, Mo or W). The particles preferably have a size in the range of less than or equal to 100 nm, or more preferably in the range of 1 nm to 100 nm, including all individual values and increments therein. The metal nanoparticles are preferably present in the above-mentioned polymer in the range of 10 wt. % to 50 wt. %, including all individual values and increments therein.

The above mixture of carbon-producing polymer and metal nanoparticles may optionally include filler particles. Such filler particles preferably include SiC, HfC, TaC, HfB₂, ZrB₂, and/or BN. The level of such filler particles in the carbon producing polymer is preferably in the range of 10 wt. % to 50 wt. %, including all individual values and increments therein.

The aforementioned carbon-producing polymer containing the metal nanoparticles and optionally the filler particles may then be applied to the ceramic coating disclosed herein. The carbon-producing polymer and metal nanoparticle may then first be applied along with preliminary heating. Then, upon selective laser heating of the carbon-producing polymer and the metal nanoparticles and optionally the filler particles, carbon is indeed produced which then react with the metals of the metal nanoparticles to form a metal-carbon coating or carbide coating. By way of example, if the metal nanoparticles comprise Ta, the aforementioned procedure provides a TaC coating.

Accordingly, one may now form a composite part herein comprising a substrate, a subsurface layer comprising graphite with a cellular structure, a graphitic layer wherein the graphitic layer comprises graphite in an amount greater than the graphite present in said subsurface layer, a ceramic coating on the graphitic layer, and a metal carbide coating on the ceramic coating. The carbide coating may preferably comprise one or more of TiC, ZIC, HfC, VC, NbC, Nb₂C, TaC, Cr₃C_{2,} Cr₇C_{3,} Cr₂₃C_{6,} MoC, Mo₂C, or WC. The carbide coating so formed preferably has a thickness in the range of 100 microns to 250 microns, including all individual values and increments therein.

1. A composite part comprising:
a substrate;
a subsurface layer comprising graphite with a cellular structure;
a graphitic layer;
wherein the graphitic layer comprises graphite in an amount greater than the graphite present in said subsurface layer; and
a ceramic coating on said graphitic layer.

2. The composite part of claim 1 wherein said ceramic coating has at thickness in the range of 10 μm to 500 μm.

3. The composite part of claim 1 wherein said ceramic coating comprises a plurality of layers wherein one of the layers provides a SiC layer and one of the layers provides a HfC layer.

4. The composite part of claim 1 wherein said ceramic coating comprises a layer containing HfC and SiC.

5. The composite part of claim 4 wherein the volume percent ratio of HfC to SiC in said ceramic coating is 2:1 to 4:1.

6. The composite part of claim 1 wherein said ceramic coating includes a surfactant at level of 0.1% (wt.) to 5.0% (wt.).

7. The composite part of claim 1 wherein said ceramic coating includes a filler.

8. The composite part of claim 7 wherein said filler is selected from one or more of SiC, HfC, TaC, HfB₂, ZrB₂ or BN.

9. The composite part of claim 1 wherein said filler has a particle size in the range of 1 nm to 500 nm.

10. The composite part of claim 7 wherein said filler is present in said ceramic coating at a level of 10% (wt.) to 40% (wt.).

11. The composite part of claim 1 wherein said ceramic coating comprises a layer containing HfC, a layer containing HfC and SiC, and a layer containing SiC.

12. The composite part of claim 1 further including a carbide coating on said ceramic coating.

13. The composite part of claim 1 wherein said carbide coating comprises one or more of TiC, ZrC, HfC, VC, NbC, Nb₂C, TaC, Cr₃C₂, Cr₇C₃, Cr₂₃C₆, MOC, Mo₂C, or WC.

14. A method of forming a composite part comprising:
providing a substrate having polymer resin and one or a plurality of additives;
performing, with a laser, a first heating operation on said polymer resin and one or a plurality of additives and forming a subsurface layer on the substrate, said subsurface layer comprising graphite with a cellular structure;
performing, with a laser, a second heating operation on said subsurface layer and forming a graphitic surface layer on said subsurface layer, wherein the graphitic layer comprises graphite in an amount greater than the graphite present in said subsurface layer;
applying a preceramic polymer to said graphitic surface layer and laser heating to form a ceramic coating.

15. The method of claim 12 wherein said ceramic coating has a thickness in the range of 10 μm to 500 μm.

16. The method of claim 12 wherein said ceramic coating comprises a plurality of layers wherein one of the layers provides a SiC layer and one of the layers provides a HfC layer.

17. The method of claim 12 wherein said ceramic coating comprises a layer containing HfC and SiC.

18. The method of claim 15 wherein the volume percent ratio of HfC to SiC in said ceramic coating is 2:1 to 4:1.

19. The method of claim 12 wherein said ceramic coating includes a surfactant at level of 0.1% (wt.) to 5.0% (wt.).

20. The method of claim 12 wherein said ceramic coating includes a filler.

21. The method of claim 18 wherein said filler is selected from one or more of SiC, HfC, TaC, HfB₂, ZrB₂ or BN.

22. The method of claim 18 wherein said filler has a particle size in the range of 1 nm to 500 nm.

23. The method of claim 18 wherein said filler is present in said ceramic coating at a level of 10% (wt.) to 40% (wt.).

24. The method of claim 12 wherein said ceramic coating comprises a layer containing HfC, a layer containing HfC and SiC, and a layer containing SiC.

25. The method of claim 14 further including:
supplying a carbon-producing polymer containing metal nanoparticles; applying said carbon-producing polymer containing said metal nanoparticles to said ceramic coating; and
laser heating of said carbon-producing polymer containing said metal nanoparticles and forming a carbide coating.
